(19) United States
(12) Patent Application Publication
(10) Pub. No.: US 2022/0319295 A1
(43) Pub. Date: Oct. 6, 2022

(54) AREA MANAGEMENT APPARATUS, AREA MANAGEMENT METHOD AND PROGRAM

(71) Applicant: NEC Corporation, Minato-ku, Tokyo (JP)

(72) Inventor: Takashi KASE, Tokyo (JP)

(73) Assignee: NEC Corporation, Minato-ku, Tokyo (JP)

(21) Appl. No.: 17/607,929

(22) PCT Filed: May 20, 2020
(86) PCT No.: PCT/JP2020/019881

§ 371 Date: Nov. 1, 2021

(30) Foreign Application Priority Data
May 21, 2019 (JP) 2019-095045

(51) Int. Cl. G08B 21/18

(52) U.S. Cl. CPC G08B 21/18

(57) ABSTRACT

An area management apparatus comprises: an entering/leaving management part that manages person(s) who enters/leaves a predetermined area and item(s) that has/have been introduced into the predetermined area by the person(s) in an associated manner, a determination part that determines whether it is required or not to remove an item introduced into the predetermined area when the item is brought into an unattended state, and a request part that requests at least a person associated with the item being in the unattended state to remove the item in a case where it is determined that the item is required to be removed.

### FIELD

### Reference to Related Application

The present invention is based on the priority of Japanese patent application No. 2019-095045 (filed on May 21, 2019), the entire contents of the same application are incorporated by reference into the present application.

The present invention relates to an area management apparatus, an area management method and program.

### BACKGROUND

Patent Literature 1 (PTL 1) discloses an abandoning monitor apparatus that may certainly output information by which an abandoning person [a person who left behind a suspicious object] can be identified even if an object other than the abandoning person is present around a suspicious object so as to enhance monitoring efficiency. An object trace means of the abandoning monitor apparatus detects object images from a monitor image so as to determine object images which are detected at time points before and after, and stores object image histories in which the object image of the determined object is historized. In addition, a suspicious object detection means analyzes the object image histories so as to detect the suspicious object that pauses for a period exceeding a pause determination time. In addition, an abandoning person detection means refers to the object image histories within a predetermined period until starting of detection of the object image of the suspicious object so as to detect all objects detected in a detection area for a suspicious object as candidate objects of the abandoning person. An event information output means selectively outputs information of the object detected by the abandoning person detection means from the object image histories.

Patent Literature 2 (PTL 2) discloses an information processing apparatus that may easily comprehend a situation upon an object was abandoned after detection of the abandoned object. The information processing apparatus detects the abandoned object from movie data and expects the time point on which the abandoned object was abandoned [left behind]. Furthermore, the information processing apparatus obtains movie data on and around an expected abandoned time point (abandoned expectation time) and controls the obtained movie data based on the abandoned expectation time so as to present at least one part of the obtained movie data to a user.

### CITATION LIST

### Patent Literature

PTL 1: Tokkai JP2011-49646A

PTL 2: International application publication WO2019/021628A

### SUMMARY

### Technical Problem

The following analysis is provided by the present invention. There is a case where a large number of persons concerned enter/leave a certain site, a large number of items are introduced therein by the persons concerned, and these items will be used after a predetermined period. For example, in a construction field, a large number of machines and tools are introduced therein, and the machines and tools are used depending on tasks. Sometime, there is a case where these machines and tools are unattended [left behind, abandoned] in the field. If these machines and tools remain being unattended, they would provide a disturbance on a construction task and a risk on safety, such as stumbling of workers and the like, thus it is required to request immediate removal thereof.

The same may occur in a waiting room or a lounge for a public transport, such as an airport. A suitcase, a large baggage, etc., which has been unattended [abandoned, left behind] may provide obstruction on passenger's traffic. In addition, the same may also occur in an event site and a backstage in which a large number of tools are used in a determined order.

With respect to this point, the technologies of above PTLs 1, 2 involve a problem that an item which is necessary for the next process on construction, an item required for safety management, and an item introduced for improvement in working environment are also uniformly determined as a suspicious object or an unattended [abandoned, left behind] item. In addition, in a case where removal notification is performed to an owner or a related person of these items, a problem may occur, such as that the owner or the related person is forced to make a useless response, and a truly required alarm is recognized as an error alarm.

It is a purpose of the present invention to provide an area management apparatus, an area management method and a program, that relates to an item described above which is introduced into a variety of areas and unattended therein [abandoned, left behind] (hereinafter referred to as “unattended item”) and that may urge an owner or a related person to make a pertinent action.

### Solution to Problem

According to a first aspect, there is provided an area management apparatus, comprising: an entering/leaving management part that manages person(s) who enters/leaves a predetermined area and item(s) that has/have been introduced into the predetermined area by the person(s) in an associated manner, a determination part that determines whether it is required or not to remove an item introduced into the predetermined area when the item is brought into an unattended state, and a request part that requests at least a person associated with the item(s) being in the unattended state to remove the item(s) in a case where it is determined that the item(s) is required to be removed.

According to a second aspect, there is provided an area management method, wherein a computer comprising an entering/leaving management part that manages person(s) who enters/leaves a predetermined area and item(s) that has/have been introduced into the predetermined area by the person(s) in an associated manner, is caused to execute processings comprising determining whether it is required or not to remove an item introduced into the predetermined area when the item is brought into an unattended state, and requesting at least a person associated with the item being in the unattended state to remove the item in a case where it is determined that the item is required to be removed. The method is associated with a specific machine as a computer that comprises the entering/leaving management part and requests removal of the item.

According to a third aspect, there is provided a computer program (hereinafter referred to as “program”), that causes a computer comprising an entering/leaving management part that manages person(s) who enters/leaves a predetermined area and item(s) that has/have been introduced into the predetermined area by the person(s) in an associated manner so as to execute: a process of determining whether it is required or not to remove an item(s) introduced into the predetermined area when the item is brought into an unattended state, and a process of requesting at least a person associated with the item being in the unattended state to remove the item in a case where it is determined that the item is required to be removed. Herein, the program may be recorded on a computer readable (non-transitory) storage medium. That is, the present invention may be realized as a computer program product. In addition, the program is input from an input apparatus or an external part to the computer apparatus via a communication interface and stored in a storage apparatus so as to drive a processor along predetermined steps or processes. Further, the program may display a process result at each stage, including an intermediate state thereof, as necessary, via a display apparatus, or may communicate with an external apparatus via a communication interface. Such computer apparatus, as one example, typically comprises a processor, a storage apparatus, an input apparatus, a communication interface and a display apparatus as necessary, which may be connected with a bus one another.

### Advantageous Effects of Invention

According to the present invention, with respect to an item which has been introduced to a variety of areas as described above and being unattended (hereinafter, referred to as “an unattended item”), it is possible to urge an owner or a relating person(s) to make a pertinent action. That is, the present invention converts the monitoring apparatuses described in the background, and the like, to a configuration markedly improved in an aspect of its function.

### BRIEF DESCRIPTION OF THE DRAWINGS

FIG. 1 is a diagram showing a configuration of one example embodiment of the present invention.

FIG. 2 is an explanatory view of operations by the example embodiment of the present invention.

FIG. 3 is an explanatory view of operations by the example embodiment of the present invention.

FIG. 4 is a diagram showing an entire construction of a first example embodiment of the present invention.

FIG. 5 is a functional block diagram of an area management apparatus of the first example embodiment of the present invention.

FIG. 6 is a diagram which shows a relationship between information registered on a database of the area management apparatus of the first example embodiment of the present invention and registration timing thereof.

FIG. 7 is a diagram which shows one example of personal management information held in a management database installed in the area management apparatus of the first example embodiment of the present invention.

FIG. 8 is a diagram which shows one example of definition information for schedule information held in the management database installed in the area management apparatus of the first example embodiment of the present invention.

FIG. 9 is a diagram which shows one example of the schedule information held in the management database installed in the area management apparatus of the first example embodiment of the present invention.

FIG. 10 is a diagram which shows one example of information held in an item image database installed in the area management apparatus of the first example embodiment of the present invention.

FIG. 11 is a diagram which shows one example of information held in an introduced-item database installed in the area management apparatus of the first example embodiment of the present invention.

FIG. 12 is a diagram which shows one example of information held in a personal equipped-items database installed in the area management apparatus of the first example embodiment of the present invention.

FIG. 13 is a diagram which shows one example of area map information held in an area map database installed in the area management apparatus of the first example embodiment of the present invention.

FIG. 14 is a diagram which shows one example of determination condition information held in a determination condition database installed in the area management apparatus of the first example embodiment of the present invention.

FIG. 15 is a sequence diagram which shows one example of operations by the area management apparatus of the first example embodiment of the present invention.

FIG. 16 is a sequence diagram which shows one example of operations by the area management apparatus of the first example embodiment of the present invention.

FIG. 17 is a sequence diagram which shows one example of determination operations by the area management apparatus of the first example embodiment of the present invention.

FIG. 18 is a sequence diagram which shows one example of determination operations by the area management apparatus of the first example embodiment of the present invention.

FIG. 19 is a diagram which shows another example of the area map information held in the area map database installed in the area management apparatus of the present invention.

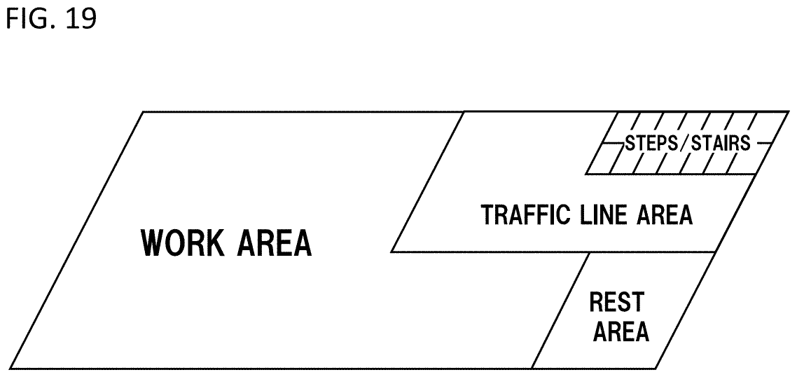

FIG. 20 is a diagram which shows another example of the determination condition information held in the determination condition database installed in the area management apparatus of the present invention.

FIG. 21 is a diagram which shows a configuration of a computer configuring the area management apparatus of the present invention.

### MODES

First, an outline of one example embodiment of the present invention is explained while referring to drawings. Herein, reference signs appended to this outline is expediently appended to each element as one example for an aid for understanding, it is not intended to limit the present invention to the mode illustrated in the drawings. In addition, a connection line between blocks in drawings and the like referred to in the following explanation includes both of bidirectional and monodirectional connections. One-way arrow schematically indicates a main signal (data) flow, but not excluding bidirectional flows. A program is executed by a computer apparatus. The computer apparatus comprises, for example, a processor, a storage device, an input device, a communication interface and a display device, if required. In addition, the computer apparatus is configured to be capable of communicating with an internal or external apparatus (including a computer) via a communication interface irrespective of cable communication or radio communication. Further, although omitted in the diagrams, a connection point of input/output of each block illustrated in the drawings comprises a port and an interface. Furthermore, in the following explanation, a phrase “A and/or B” is used for referring to either of “A or B” or “A and B”.

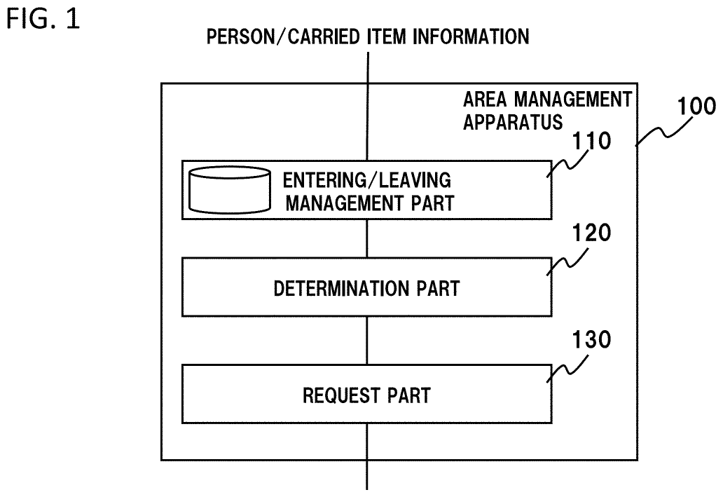

In one example embodiment, the present invention may be realized by an area management apparatus 100 comprising an entering/leaving management part 110, a determination part 120, a request part 130 as illustrated in FIG. 1. More concretely, the entering/leaving management part 110 manages person(s) who enters/leaves a predetermined area with item(s) that has/have been introduced into the predetermined area by the person(s) in an associated manner. The determination part 120 determines whether it is required or not to remove an item introduced into the predetermined area when the item(s) is brought into an unattended state. In addition, the request part 130 requests at least a person associated with the item being in the unattended state to remove the item in a case where it is determined that the item(s) is required to be removed.

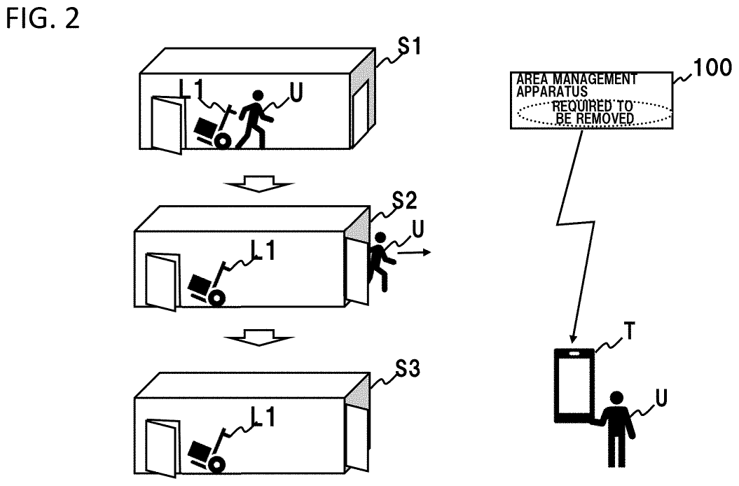

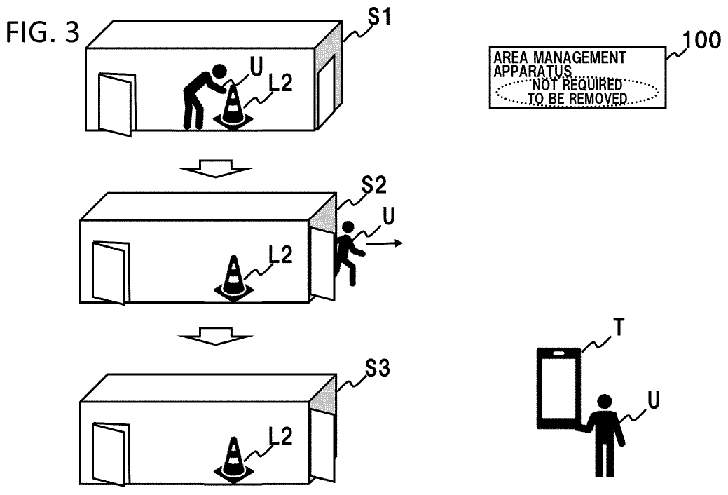

Herein, operations by the area management apparatus 100 are explained using FIGS. 2, 3. For example, as illustrated in FIG. 2, it is given that, an entering/leaving person U introduces an item L1 (for example, a cart) into a predetermined area (a room in FIG. 2) and it is also given that it would be determined that the item L1 is required to be removed when the item L1 is brought into an unattended state. In such case, the entering/leaving management part 110 manages the person U and the item L1 in an associated manner (see step S1 in FIG. 2). After that, when the person U leaves the predetermined area (the room in FIG. 2), the item L1 is brought into an unattended state (see step S2 in FIG. 2). The determination part 120 determines whether it is required or not to remove the item L1. In this case, since the item L1 (for example, the cart) is determined as “REQUIRED TO BE REMOVED”, the request part 130 sends a message to a terminal T of the person U, by which it is requested to remove the item L1 being in the unattended state (see right side of step S3 in FIG. 2).

On the other hand, as illustrated in FIG. 3, it is given that, the entering/leaving person U introduces an item L2 (for example, a triangle cone (traffic pylon)) into the predetermined area (the room in FIG. 2[sic, FIG. 3]) and placed the item L2 at a required site, and it is also given that it would be determined that the item L2 is not required to be removed even when the item L2 is brought into the unattended state. In such case, the entering/leaving management part 110 also manages the person U and the item L2 in an associated manner (see step S1 in FIG. 3). After that, when the person U leaves the predetermined area (the room in FIG. 3), the item L2 is brought into an unattended state (see step S2 in FIG. 3). The determination part 120 determines whether it is required or not to remove the item L2. In this case, the item L2 (for example, the triangle cone) is determined as “NOT REQUIRED TO BE REMOVED”. Therefore, the request part 130 does not execute any removal requests to the person U (see right side in FIG. 3).

Herein, with respect to the above determination by the determination part 120 as to whether the item is required or not to be removed, a simple scheme may be also adopted, in which a determination as “NOT REQUIRED TO BE REMOVED” is made in only a case where the item is determined as a specific item as a result of image recognition, and a determination as “REQUIRED TO BE REMOVED” is made in the other cases. For example, in the cases of the above examples, it is considered that the determination part 120 is so configured to make determination as “NOT REQUIRED TO BE REMOVED” in a case where the item is recognized as the triangle cone or a variety of signposts and the like, and to make determination as “REQUIRED TO BE REMOVED” in the other cases.

In contrast, a scheme may be also adopted, in which a determination as “REQUIRED TO BE REMOVE” is made in only a case where the item is determined as a specific item as a result of image recognition, and a determination as “NOT REQUIRED TO BE REMOVED” is made in the other cases. For example, in the cases of the above examples, it is considered that the determination part 120 is so configured to make determination as “REQUIRED TO BE REMOVED” in a case of recognizing it as a cart, a hand truck, a baggage and the like, and to make determination as “NOT REQUIRED TO BE REMOVED” in the other cases.

As explained above, according to the present invention, it is made possible to determine whether an unattended item is required or not to be removed, and, when being determined as “REQUIRED TO BE REMOVED”, to request a person who has introduced the item to remove the item. Thereby, it is made possible to prevent occurrence of a situation that the unattended item interferes with construction tasks and a situation that the unattended item causes tumbling of a worker.

### First Example Embodiment

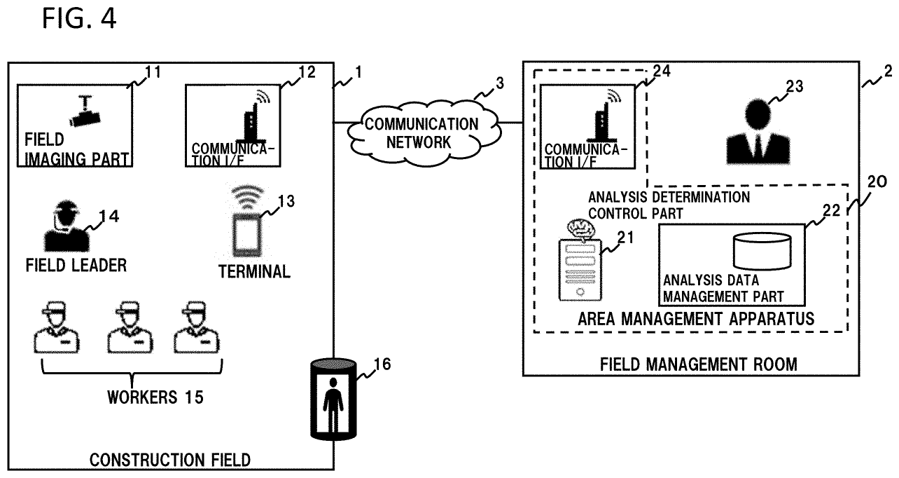

Next, a first example embodiment is explained in detail while referring to drawings, in which the present invention is applied to item management in an area at a construction field (or site). FIG. 4 is a diagram showing an entire configuration of the first example embodiment of the present invention. Referring to FIG. 4, a configuration is illustrated, in which a construction field 1 and a field management room 2 are connected via a communication network 3.

The construction field 1 is a closed space, and entrance-registration management for workers 15 including a field leader 14 who work therein is performed at a place where an image is captured. It is given that the construction field 1 is separated into a work area and a traffic line area as described later on.

The field management room 2 is a place where an area management apparatus 20 comprising an analysis determination control part 21, an analysis data management part 22, and a communication interface (communication I/F) 24 is arranged, and analysis of image transmitted from a field imaging part 11 at the construction field 1 and the like are executed. In addition, in the field management room 2, and a field manager 23 is arranged, who manages the construction field 1 entirely. If required, the field manager 23 performs operations on the analysis determination control part 21 and the analysis data management part 22 of the area management apparatus 20.

In the construction field 1, the field imaging part 11, a communication interface (communication I/F) 12 and a terminal 13 are arranged. The field imaging part 11 is configured with a monitor camera that captures the construction field 1. Herein, the number of the monitor camera is arbitrary, thus entire field may be covered by one monitor camera or a configuration may be also adopted in which a plurality of monitor cameras capture the entire field. The image captured by the field imaging part 11 is transmitted to the side of field management room 2 to be used for determination of requirement or non-requirement of removal of an unattended item.

The communication I/F 12 and the communication I/F 24 are communication apparatuses such as a wireless router, etc., which relays communication between the construction field 1 and the field management room 2 via the communication network 3.

The terminal 13 is a communication apparatus such as a cellular phone, a smartphone, etc. The terminal 13 is held by each of the field leader 14 and the workers 15 respectively, and used as a transmission destination of a message by which removal of the unattended item is requested.

The field leader 14 is a supervisor for field tasks, who belonging to the same construction firm as the plurality of workers 15. In the present example embodiment, although a premise is provided that the field leader 14 does not perform any activities on construction tasks, since he is being in the construction field 1, he is treated as a transmission destination of the message requesting removal of unattended item, like as the workers 15.

A security gate 16 is a gate apparatus that executes entering/leaving management for person(s) who enters/leaves the construction field 1. The security gate 16 is provided with a camera, and the security gate 16 may capture face images for facial authentication of the entering/leaving persons, an item introduced by the workers etc., and equipped items including working clothes and may transmit the images to the side of the field management room 2.

Herein, in the present example embodiment, explanation is made with an assumption that processing for facial authentication and image recognition based on information transmitted from the security gate 16 are executed in the analysis determination control part 21.

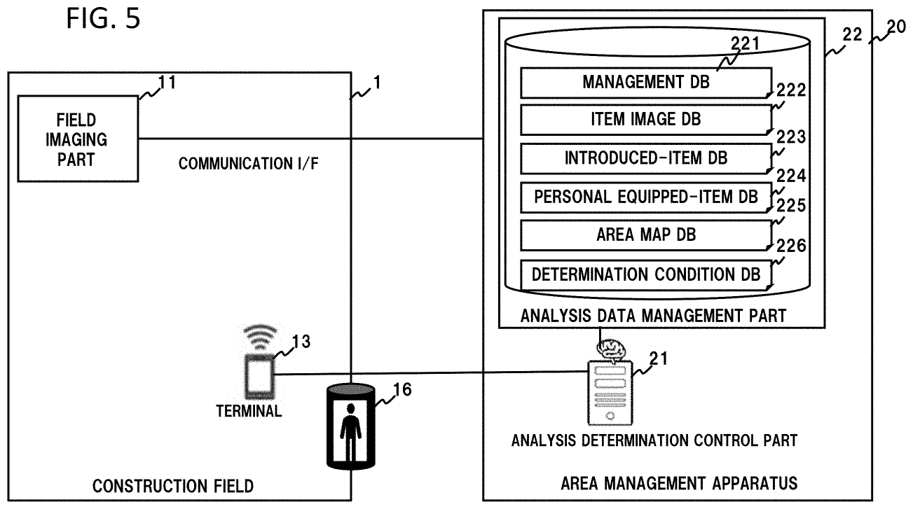

Next, a configuration of the area management apparatus 20 is explained, which is arranged in the above field management room 2 and executes a variety of processing based on data transmitted from the field imaging part 11 and the security gate 16. FIG. 5 is a functional block diagram illustrating a detail configuration of the area management apparatus 20.

Referring to FIG. 5, the analysis data management part 22 comprises a management database (management DB, hereinafter “database” is referred to as “DB”) 221. The analysis data management part 22 further comprises an item image DB 222, an introduced-item DB 223, a personal equipped-item DB 224, an area map DB 225, and a determination condition DB 226. Data managed by these DBs is explained below.

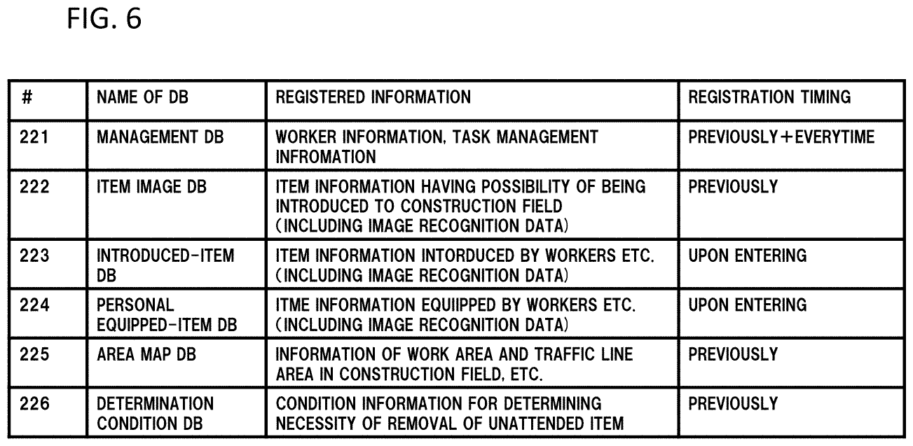

FIG. 6 is a figure showing relationships between information registered on each of the above DBs and registration timing thereof.

Information involving “PREVIOUSLY” as the registration timing is previously input via an external server and a PC (personal computer), mainly. In addition, information involving “UPON ENTERING” as the registration timing is input via the security gate 16 when the workers 15 and the field leader 14 enter the construction field 1, mainly. Details of these registration information are explained below.

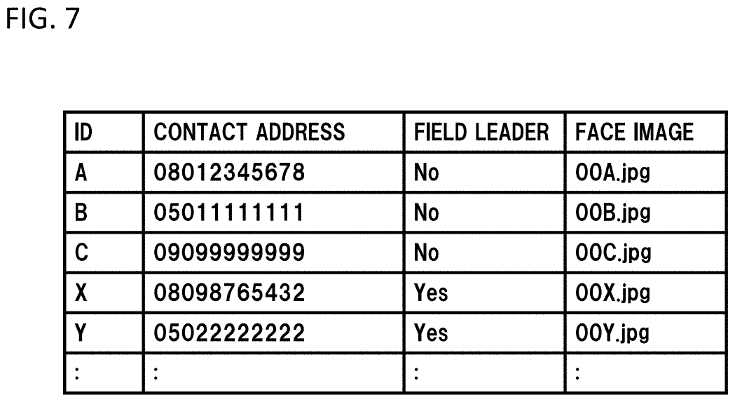

FIG. 7 is a figure showing an example of personal management information held by the management DB 221. In the example of FIG. 7, a table is exemplified, in which contact address, information indicating the field leader or not, and face image of each person assigned to ID: A to C, X, Y are associated. The contact address is a telephone number of the terminal 13 held by each person and the like, and used as a transmission destination of a message sent to each person.

In addition, in place of the telephone number, a mail address and an account information used for SNS (Social Networking Service) may be registered depending on a scheme for sending the message. In addition, in a case where a field leader column is “Yes”, it is indicated that the person is a field leader, and in a case of “No”, it is indicated that the person is a worker. Herein, although one image having a filename extension of jpg as the face image is held in the example in FIG. 7, the face image may be multiple. In addition, feature data of face of each person, which is used for facial authentication, may be held instead of these face images.

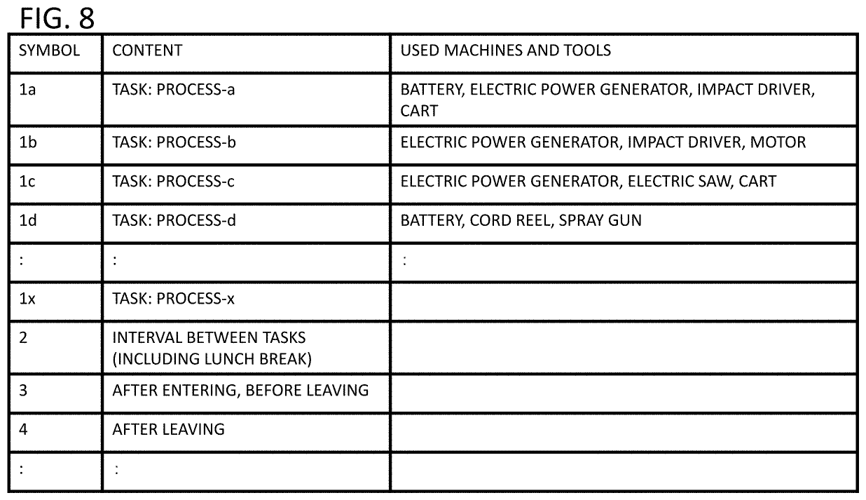

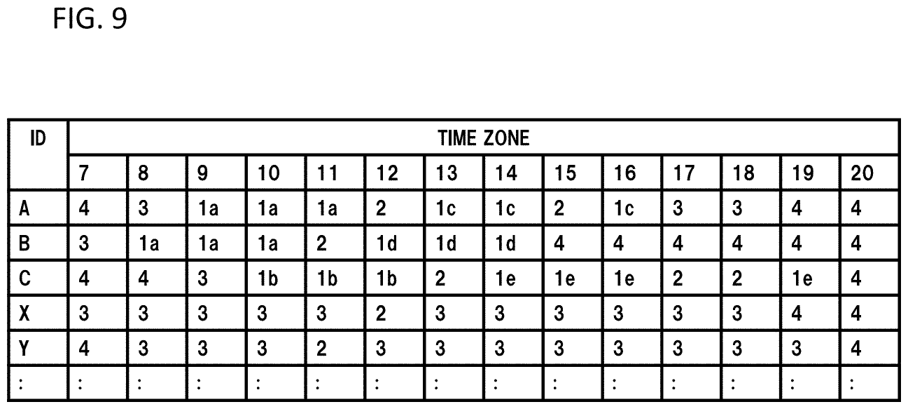

FIG. 8 is a table, in which contents of tasks assigned to symbols used in a schedule table (process table) described later on and machines and tools used in the tasks are defined. Details of these will be explained together with an example of the schedule table (process table) in FIG. 9.

FIG. 9 shows a construction schedule table (process table) of the workers 15 and the field leader 14 on a certain day, which is held on the management DB 221. In an example of FIG. 9, schedules of individual persons from at 7 o'clock in the morning (7 AM) to at 20 o'clock are indicated with the symbols defined in FIG. 8. For example, the worker of ID=A has not entered the field at a time point of 7 AM because of SYMBOL:4 (AFTER LEAVING). In addition, at a time point of 8 AM, the worker of ID=A is scheduled to enter the field because of SYMBOL:3 (AFTER ENTERING, BEFORE LEAVING). In addition, at 9 AM, because of 1a (PROCESS-a), the worker of ID=A is scheduled to start a task of PROCESS-a. In addition, according to the schedule table in FIG. 9, the worker of ID=A performs the task of PROCESS-a until at 12 o'clock, and has a lunch break for 1 hour from 12 o'clock because of SYMBOL:2 (INTERVAL BETWEEN TASKS, INCLUDING LUNCH BREAK). After that, the worker of ID=A performs a task of PROCESS-c for 2 hours from 13 o'clock, and then has a short break for 1 hour from 15 o'clock because of SYMBOL:2 (INTERVAL BETWEEN TASKS). After that, the worker of ID=A perform a task of PROCESS-c for 1 hour from 16 o'clock, then makes preparation for going back home, and being scheduled to subsequently leave at 19 o'clock.

Herein, in FIG. 9, since it is given that the field leaders of

ID=X, Y do not perform any activities for tasks, either of SYMBOL:2 (INTERVAL BETWEEN TASKS) or SYMBOL:3 (AFTER ENTERING, BEFORE LEAVING) is applied during staying in the field.

Herein, all boxes (fields) in the above schedule table are unnecessary to be previously created (occupied). A configuration may be also adopted, in which SYMBOLs:1a to 1x and SYMBOL:2 are previously registered and boxes for SYMBOLs:3, 4 are updated at the security gate 16.

In addition, as indicated in FIG. 8, machines used in each process are defined. Therefore, by referring to the schedule table in FIG. 9 and the table in FIG. 8, it is possible to determine whether a machine is used or not in the just time zone and the next time zone.

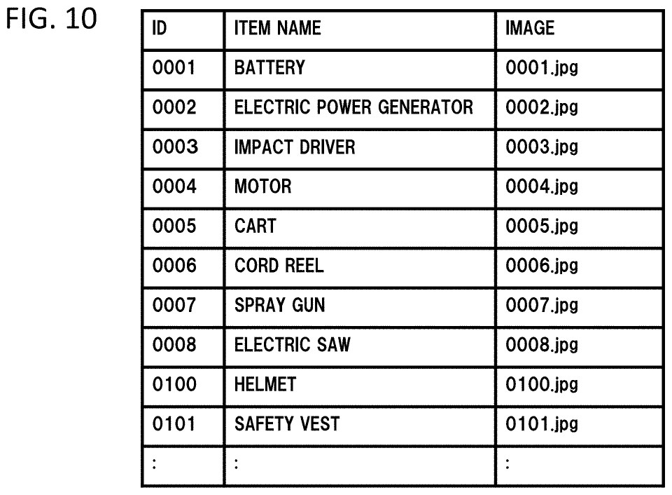

FIG. 10 is a figure showing one example of item image information held by the item image DB 222. A table is exemplified in the example in FIG. 10, in which item name (name) of items assigned to ID: 0001- and images thereof are associated. In the example of FIG. 10, although one image having a filename extension of jpg is held as the item image, the item image may be multiple. In addition, feature data of the item image, which is used for authentication of an item, may be held instead of these item images.

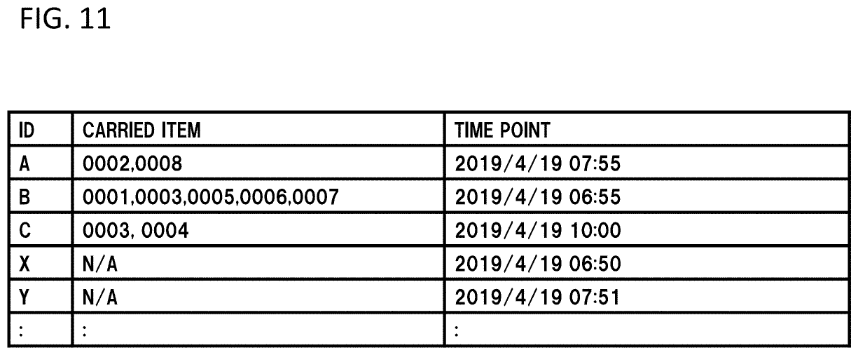

FIG. 11 is a figure indicating one example of introduced-item information held by the introduced-item DB 223. A table is exemplified in the example in FIG. 11, in which IDs of workers, IDs of items (carried item) introduced by the workers, and time points of being introduced are associated. In the example of FIG. 11, it is recorded that the worker of ID=A has introduced an ELECTRIC POWER GENERATOR of ID=0002 and an ELECTRIC SAW of ID=0008 at 07:55 in the morning, which are used for PROCESS-a. Herein, worker's face may be identified by comparing a face image held in the management DB 221 in FIG. 7 with a face image captured at the security gate 16.

In addition, the items (CARRIED ITEM) introduced by the worker of ID=A may be identified by comparing the item image held in the item image DB 222 of FIG. 10 with an item in an image captured at the security gate 16.

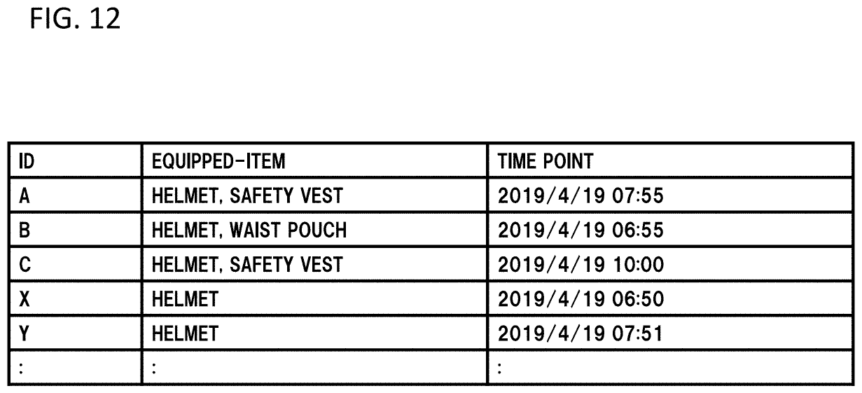

FIG. 12 is a figure indicating one example of personal equipped-item information held in the personal equipped-item DB 224. A table is exemplified in the example in FIG. 12, in which IDs of the workers, IDs of the items equipped by the workers (EQUIPPED-ITEM), and time points of being introduced are associated. In the example of FIG. 12, it is recorded that a HELMET and a SAFETY VEST are equipped by the worker of ID=A.

Herein, the items(s) and equipped-item(s) described above may be identified by comparing feature data obtained from the item image held in the item image DB 222 in FIG. 10 with feature data obtained from image of the item(s) and the equipped-item(s), which are captured at the security gate 16. Of course, an image recognition system utilizing AI (Artificial Intelligence) may be used for identification of the item(s) and the equipped-item(s).

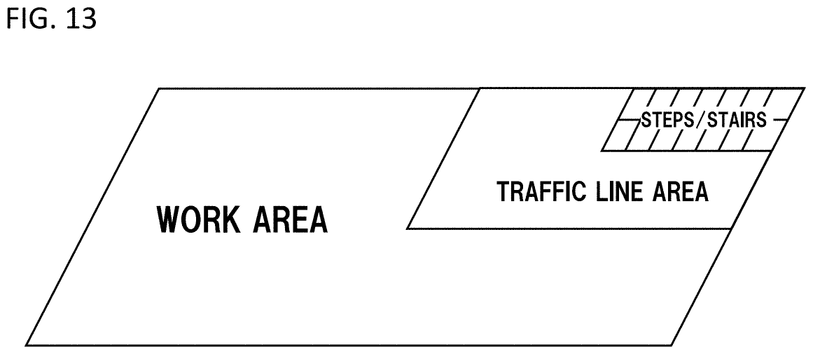

FIG. 13 is a figure illustrating one example of area map information held in the area map DB 225. In the example in FIG. 13, exemplified is an area map information separated into a WORK AREA and a TRAFFIC LINE AREA including STEPS/STAIRS. The traffic line area among them is an area (prohibited area) in which an unattended item is requested to be removed regardless of necessity/unnecessity of the item for any tasks. On the other hand, the work area is an area in which an unattended item is requested to be removed in a case where the item is unnecessary for any tasks. Herein, although an example in which two areas of the work area and the traffic line area are arranged is illustrated in the example of FIG. 13, the configuration of the area map is not limited thereto. For example, a third area (for example, installation area for machines and materials) other than the work area and the traffic line area may be arranged. In addition, two or more of the work area and the traffic line areas may be arranged respectively.

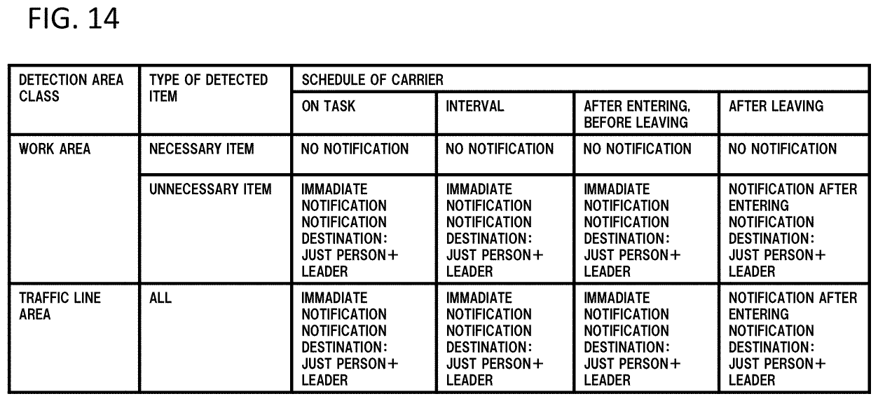

FIG. 14 is a figure indicating one example of determination condition information held in the determination condition DB 226. In the example of FIG. 14, in a case where an unattended item is detected in the construction field 1, different handling manners are applied to the unattended item depending on a factor that the position thereof is in the traffic line area or in the work area. In a case where the unattended item is detected in the traffic line area, a message is sent regardless of the type of the item, by which it is requested to remove the item (see DETECTION AREA CLASS=TRAFFIC LINE AREA, AND, TYPE OF DETECTED ITEM=ALL in FIG. 14). In addition in the example of FIG. 14, the person who has introduced the item [referred to as “JUST PERSON”]+a (field) LEADER are set as transmission destinations (NOTIFICATION DESTINATION) of the message for requesting removal of the item. Further, these notifications are notified immediately excepting a case where the just person and the leader have [already] left there. Thereby, immediate removal of the unattended item(s) in the traffic line area is achieved. In addition, in the example of FIG. 14, since the (field) leader is set as the NOTIFICATION DESTINATION in addition to the workers, a request for removal of the unattended item(s) may be provided to the (field) leader even in a case where the worker is hung up with a certain task. Of course, the notification destination may be set to workers belonging to the same group as the worker concerned [the person concerned], and/or worker(s) who cooperates to the same task process, and/or another (field) leader, instead of the field leader.

On the other hand, under a situation where the unattended item is detected in the work area and in a case where the item type is UNNECESSARY ITEM, a message for requesting removal of the item is sent like as the case where the unattended item is found in the traffic line area. This [situation/case] corresponds to a case [or an entry] that the detection area class is the work area and detected item type is unnecessary item in FIG. 14, and thus a process depending on a carrier schedule is selected. Herein, in the example of FIG. 14, the person who has introduced the item [i.e., JUST PERSON]+the (field) LEADER are set as the transmission destinations of the message for requesting removal of the item. Further, these notifications are notified immediately excepting a case where the just person or the leader have [already] left there. Thereby, immediate removal of the unattended item in the work area is achieved.

On the other hand, in a case where the unattended item which is detected in the work area has the item type of NECESSARY ITEM, the message for requesting removal of the item is not sent (see DETECTION AREA CLASS=WORK AREA, AND, TYPE OF DETECTED ITEM=NECESSARY ITEM in FIG. 14). Thereby, transmission of a removal message for a necessary item in the work area is prevented.

The analysis determination control part 21 updates contents in the management DB 221 of the analysis data management part 22 based on data received from the field imaging part 11 and the security gate 16 in the construction field 1. Therefore, in the present example embodiment, it is given that the analysis determination control part 21 functions as the entering/leaving management part 110. In addition, the analysis determination control part 21 determines whether it is required or not to remove the unattended item(s) and then performs notification to a required contact address as described later on. Therefore, in the present example embodiment, it is given that the analysis determination control part 21 also functions as the determination part 120 and the request part 130.

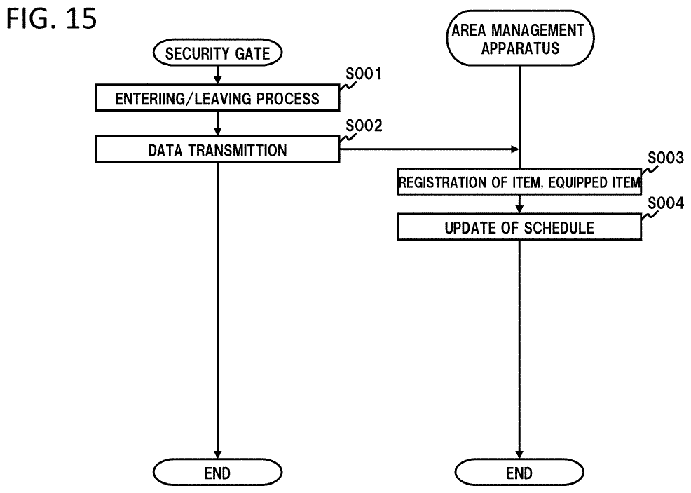

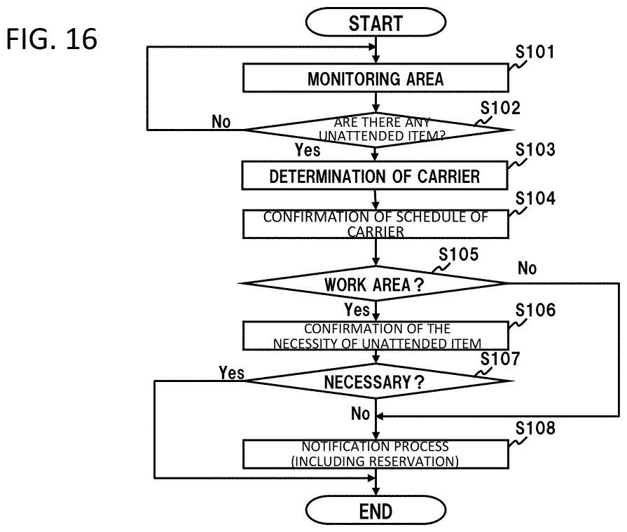

Next, operations by the above described area management apparatus 20 is explained in detail while referring to drawings. FIG. 15 and FIG. 16 are flow diagrams of one example of operations by the area management apparatus of the first example embodiment of the present invention. In the following explanation, the explanation is made with an assumption that information indicating that the registration timing is “PREVIOUSLY” in FIG. 6 has been registered previously.

Referring to FIG. 15, when each of the field leader 14 and the workers 15 passes through the security gate 16 (step S001), information is obtained at the security gate 16, and then transmitted to the side of the area management apparatus 20 (step S002). For example, when the worker 15 successes in facial authentication at the security gate 16 and then enters the field, registration of the entrance is executed. In addition, the area management apparatus 20 refers to the item image DB 222 so as to identify the items introduced by the worker(s) 15 and equipped-item(s) from the image obtained at the security gate 16 (step S003). The area management apparatus 20 registers the item(s) and equipped-item(s) identified on the introduced-item DB 223 and the personal equipped-item DB 224 as the carried item(s) and the equipped-item(s) of a corresponding worker, respectively (see FIG. 11, FIG. 12). Above functions of the area management apparatus 20 corresponds to the entering/leaving management part 110 above.

Herein, upon obtaining images of the item(s) and the equipped-items, the security gate 16 may output a message to the worker 15 so that the worker 15 exhibits the item(s) and the equipped-item(s) within a view of an installed camera. Thereby, it is given that image suitable for recognition may be obtained.

In addition, the area management apparatus 20 updates the schedule table of the corresponding field leader 14 and workers 15, which is held in the management DB 221, as a response to the entering/leaving process (step S004). For example, in a case where a worker A enters there at 8 o'clock in the morning [referred to as “8 AM”], whose entrance has been scheduled at 8 AM, the symbol of time zone=SYMBOL:8 for the worker A is rewritten/updated with SYMBOL:3. Herein, in a case where the worker A enters there one hour earlier at 7 AM, whose entrance has been scheduled at 8 AM, the symbol of time zone=SYMBOL:7 for the worker A is updated from SYMBOL:4 to SYMBOL:3 so that entering of the worker A into the field may be comprehended. Similarly, the symbol of a corresponding time zone is also updated to “SYMBOL:3” or “SYMBOL:4” in cases where the worker A comes there late or leaves there earlier.

After that, as illustrated in FIG. 16, the area management apparatus 20 monitors the area based on image captured by the field imaging part 11 (step S101). In a case where an unattended item is detected during the monitoring process (step S102, Yes), the area management apparatus 20 executes process step S103 and subsequent processes in FIG. 16. Herein, as a detection method of the unattended item in step S102, a method may be used, in which, using a plurality of images capturing the same site with a constant time interval (for example, 5 seconds), an item which appears on a certain time point and remains there after the time point is determined as an unattended item. In addition, as a detection method for the item itself, a method may be adopted, in which an image capturing an area of a state where no unattended item is placed with an image captured by the field imaging part 11 are compared, and the item and the position thereof are determined using a difference between them. Alternatively, a variety of methods disclosed in PTLs 1, 2 may be used for detection of the unattended item(s).

In a case where the unattended item is found, the area management apparatus 20 determines a person who carried the unattended item (step S103). As a determination method for the person who carried the unattended item, a method may be used, in which a person who placed the unattended item is determined using facial authentication from an image of a person captured in an image in which the unattended item is detected. In addition, in a case where a person who is captured in an image looks back, and in a case where (high) accuracy for the facial authentication cannot be expected because of reasons, such as unclearness of the image, the area management apparatus 20 may select a person(s) concerned by referring to the introduced-item DB 223 and the personal equipped-item DB 224. Concretely, the area management apparatus 20 refers to the introduced-item DB 223 and the personal equipped-item DB 224 and selects one or more persons concerned from persons who introduced or equipped the concerned item so that the person may be determined.

Next, the area management apparatus 20 refers to the schedule table of the workers 15 or the field leader 14 determined in step S103 and confirms scheduled contents at the time point on which the unattended item of the concerned person (step S104).

Next, the area management apparatus 20 refers to the area map information held in the area map DB 225 and determines whether the position at which the unattended item is placed is the work area or not (step S105). Herein, in a case where the area in which the unattended item is placed is the traffic line area, the area management apparatus 20 proceeds to step S108 by skipping steps S106, S107. On the other hand, in a case where the area in which the unattended item is placed is the work area (step S105, Yes), the area management apparatus 20 confirms whether the item is an item necessary in a task step (step S106).

In step S106, in first, the area management apparatus 20 refers to the schedule table (see FIG. 9), and confirms task steps subsequent to the task step currently performed. Next, the area management apparatus 20 determines (infers) machines/materials used in each of the task steps (see FIG. 8), and determines whether the unattended item is required or not in the subsequent tasks. For example, in a case where the schedule table in FIG. 9 is referred to on the time point of 14 o'clock, tasks to be performed in the day are only task steps of SYMBOLs:1 c, 1d, 1e. In a case where the unattended item is an impact driver, the impact driver is determined as “unnecessary”, since it is used in only task step of SYMBOL:1b. On the other hand, in a case of a battery, the battery is determined as “NECESSARY”, since it is used in task step of

SYMBOL:1 d (see FIG. 8, FIG. 9).

In a case where the unattended item is determined as “NECESSARY” as a result of the determination in step S106 (step S107, Yes), the area management apparatus 20 skips a notification process in step S108 and terminates the sequential processes. In such case, it is given that, on the next timing, the processes in FIG. 16 are executed so as to determine the position and the necessity of the [concerned] unattended item, again.

In a case where the unattended item is determined as “unnecessary” as a result of the determination in step S106 (step S107, No), and in a case where the unattended item is placed in the traffic line area, the area management apparatus 20 reads out the notification condition and the notification destination in the determination condition

DB 226. The above functions of the area management apparatus 20 correspond to the above described determination part 120.

Further, the area management apparatus 20 reads out the contact address of the workers 15 or the field leader 14 from the management DB 221, which is registered as the notification destination, and transmits a notification to the corresponding contact address, by which removal of the unattended item is requested (step S108). The workers 15 or the field leader 14 who received the notification perform removal of the unattended item. The above functions of the area management apparatus 20 correspond to the above described request part 130.

Herein, the notification for requesting removal of the unattended item may include an image of the unattended item, and information by which the time or the place at which the unattended item was placed may be recognized. Herein, in a case where the notification condition is “IMMEDIATE NOTIFICATION” in the determination condition DB 226, the area management apparatus 20 immediately executes notification to the contact address concerned. On the other hand, in a case where the notification condition is “NOTIFICATION AFTER ENTERING” in the determination condition DB 226, the area management apparatus 20 executes notification at the timing of entering of the workers 15 concerned or field leader 14 into the construction field (executing notification RESERVATION). Thereby, certain removal of the unattended item may be requested upon the next entering of the workers 15 or the field leader 14. Herein, even under a situation where the workers 15 have left there, if it is confirmed that the field leader 14 is still staying in the construction field as a result of confirmation on the schedule table, the notification for requesting removal of the unattended item may be transmitted to the field leader 14.

In addition, in a case where there is a time lag from detection of the unattended item to the notify, it is also preferable to confirm again whether the unattended item is still placed or not on the same site before the notification, and to prevent the notification if transfer thereof has been performed.

As explained above, the area management apparatus 20 of the present example embodiment determines necessity/unnecessity of removal of an automatically detected unattended item and executes automatic notification, but not only determines (infers) a person who introduced the unattended item from an image of the unattended item. Thereby, an item disturbing a task may be immediately excluded from the field so that working efficiency and safety may be improved. In addition, according to the present example embodiment, burden on a field manager who manages the field may be reduced.

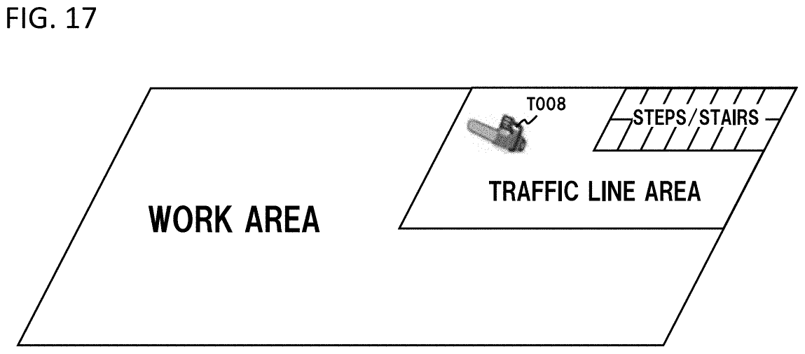

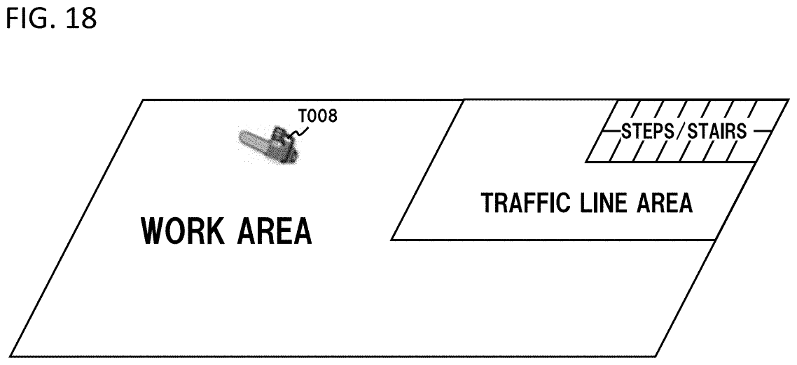

In addition, the area management apparatus 20 of the present example embodiment may prevent useless notification and reduce disturbance on the task as much as possible, since the notification is made after confirmation of the position at which the unattended item is placed and necessity/unnecessity thereof. For example, in a case where an electric saw T008 is placed and unattended in the traffic line area as illustrated in FIG. 17, the area management apparatus 20 requests the workers 15 and the field leader 14 removement thereof immediately. On the other hand, in a case where the electric saw T008 is placed and unattended in the work area as illustrated in FIG. 18, it is determined whether the electric saw T008 is necessary or unnecessary in subsequent tasks, and if determined as unnecessary, the workers 15 and the field leader 14 are requested to remove it. Thereby, useless notification would not be executed, such as requesting removal of an item required in a task.

Although each example embodiment of the present invention is explained above, the present invention is not limited to the example embodiments described above, further deformation, substitution, adjustment may be added thereto within an ambit not out of the basic technical concept of the present invention. For example, system configuration, configuration of each element, configuration of DBs illustrated in each figure, and the like are an example of an aid for understanding the present invention, thus not limited to the configurations illustrated in these figures.

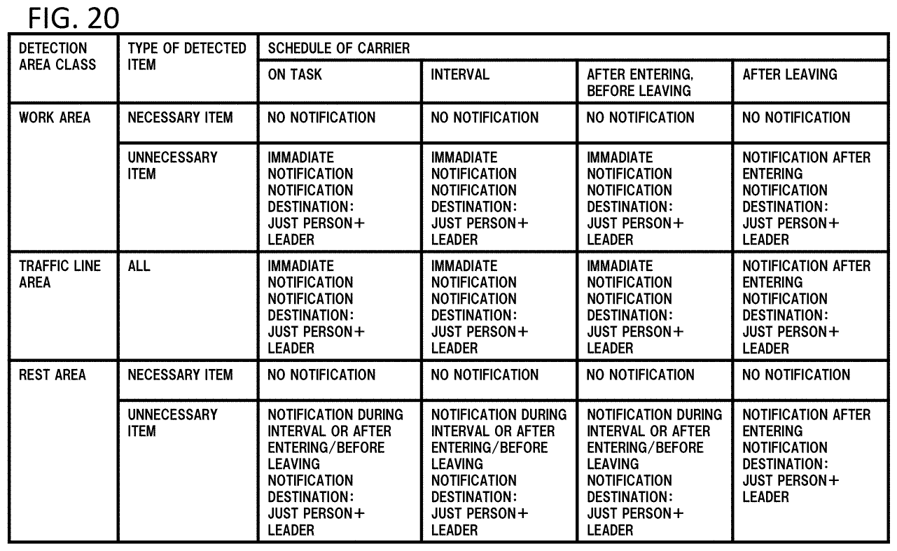

For example, in the example embodiments described above, the explanation is made with an assumption that used is area map information separated into two types of area of the WORK AREA and the TRAFFIC LINE AREA, a third area may be defined therein, which does not provide any disturbance on tasks, such as a REST AREA, etc. For example, in an example of FIG. 20, the REST AREA is added as the third area. With respect to an item placed in the rest area, since immediacy to an extent that the notification is performed during a task is not requested, the notification condition is also need not be “IMMEDIATE NOTIFICATION”. For example, as illustrated in FIG. 20, the “REST AREA” as the detection area class may be added, and an entry including notification conditions of “INTERVAL (between tasks)” or “AFTER ENTERING, BEFORE LEAVING” as the notification condition may be added. Thereby, it is possible to perform the notification within a time period at which the workers do not perform any tasks.

For example, although the area management apparatus 20 refers to the schedule table (process table) so as to determine the necessity/unnecessity of removal of the unattended item in the example embodiment described above, the area management apparatus 20 may refer to the other information so as to determine the necessity/unnecessity of removal of the unattended item. For example, in a case where a site at which the area management apparatus 20 is established is an event site or a backstage thereof, it is given that the area management apparatus 20 refers to information corresponding to a process table, such as an event program, a scenario/script, or the like, so as to determine whether the unattended item(s) is required or not in an event or a task which would be performed subsequently.

For example, although, in the example embodiment described above, the explanation is made with an assumption that the area management apparatus 20 executes notification to not only the workers 15 but also to the field leader 14, the example of the notification destination is not limited to the field leader 14. For example, the management DB 221 may hold information on a group to which the workers 15 belonging, and may request members belonging the same group to remove the unattended item. Thereby, the other group members may be requested to remove the unattended item even if the workers 15 and the field leader 14 are being in a lunch break.

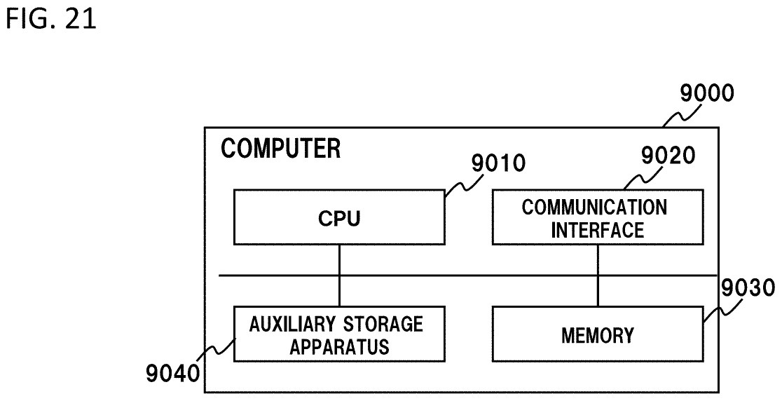

In addition, the processes described in the above first example embodiment may be realized by a program causes a computer (FIG. 20, 9000) that functions as the area management apparatus 20 to implement functions as the area management apparatus 20. Such computer is exemplified by a configuration in FIG. 21, that comprises a CPU (Central Processing Unit) 9010, a communication interface 9020, a memory 9030, and an auxiliary storage apparatus 9040. That is, an unattended item detection program and a notification necessity determination program may be executed in CPU 9010 in FIG. 21 so as to execute update process of each calculation parameter held in the auxiliary storage apparatus 9040 and the like.

That is, each part (process means, function) in the area management apparatus 20 described in the first example embodiment may be realized by a computer program that causes a processor installed in the area management apparatus 20 to execute each of processes described above using its hardware.

Last, preferable modes of the present invention are summarized.

### [First Mode]

(See the area management apparatus according to the above described first aspect.)

### [Second Mode]

A configuration may be adopted, in which the entering/leaving management part of the above described area management apparatus receives a captured image of a person who enters/leaves the predetermined area and manages the person recognized from the captured image and the item(s) in an associated manner.

### [Third Mode]

A configuration may be adopted, in which the determination part of the above described area management apparatus determines that it is not required to remove the item in a case where the item is necessary in a task or an event that is being carried out in the predetermined area, and determines that it is required to remove the item in a case where the item is unnecessary in a task or an event that is being carried out in the predetermined area.

### [Fourth Mode]

A configuration may be adopted, in which the determination part of the above described area management apparatus refers to a process table for a task or an event that is being carried out in the predetermined area so as to determine whether it is required or not in the task or event that is being carried out in the predetermined area.

### [Fifth Mode]

A configuration may be adopted, in which the determination part of the above described area management apparatus, in a case where the item is positioned in a predetermined unattending-prohibition area, the determination part determines that the item is required to be removed regardless of the necessity/unnecessity of the item in the task or the event.

### [Sixth Mode]

A configuration may be adopted, in which the entering/leaving management part of the above described area management apparatus holds contact address information of the person(s) who enters/leaves the predetermined area, and
the request part sends a message to the contact address of the person(s) who introduced the item into the predetermined area so as to request removal of the item in the unattended state.

### [Seventh Mode]

A configuration may be adopted, in which contact address information of member(s) who belongs to the same group as the person(s) who enters/leaves the predetermined area is held, and
the request part sends a message to a contact address of a member who belongs to the same group as the person who introduced the item into the predetermined area in addition to the person who introduced the item so as to request removal of the item in the unattended state.

### [Eighth Mode]

(See the area management method according to the above described second aspect.)

### [Ninth Mode]

(See the program according to the above described third aspect.)
Herein, the eighth to ninth modes may be developed to second to seventh modes like as the first mode.

Herein, it is considered that the disclosures of the above Patent Literatures are incorporated herein by reference thereto, and the disclosures may be used as a base or a part of the present invention as necessary. Variations and adjustments of the example embodiments are possible within the ambit of the entire disclosure (including the claims) of the present invention and based on the basic technical concept of the present invention. Various combinations and selections (including non-selection) of various disclosed elements (including each element in each claim, each example embodiment, each drawing, etc.) are possible within the ambit of the disclosure of the present invention. Namely, the present invention of course includes various variations and modifications that could be made by those skilled in the art according to the overall disclosure including the claims and the technical concept. Particularly, a numerical value range described in the present description should be interpreted as describing arbitrary numerical values or small ranges included in the ranges, even if they are not described explicitly. Further, each of the disclosed matters of the above cited literatures is regarded as included in the described matters in the present application, if required, on the basis of the concept of the present invention, as a part of description of the present invention, also that a part or entire thereof is used in combination with a described matter(s) in the present application.

### REFERENCE SIGNS LIST

1 construction field (or site)
2 field management room
3 communication network
11 field imaging part
12, 24 communication interface (communication I/F)
13 terminal
14 field leader
15 workers
16 security gate
20, 100 area management apparatus
21 analysis determination control part
22 analysis data management part
23 field manager
110 entering/leaving management part
120 determination part
130 request part
221 management database (DB)
222 item image database (DB)
223 introduced-item database (DB)
224 personal equipped-item database (DB)
225 area map database (DB)
226 determination condition database (DB)
9000 computer
9010 CPU
9020 communication interface
9030 memory
9040 auxiliary storage apparatus

What is claimed is:

1. An area management apparatus, comprising:
a memory storing instructions; and
at least one processor configured to execute the instructions to perform:
managing person(s) who enters/leaves a predetermined area and item(s) that has/have been introduced into the predetermined area by the person(s) in an associated manner,
determining whether it is required or not to remove an item introduced into the predetermined area when the item is brought into an unattended state, and
requesting at least a person associated with the item(s) being in the unattended state to remove the item(s) in a case where it is determined that the item(s) is required to be removed.

2. The area management apparatus according to claim 1, wherein the processor is configured to execute the instructions to perform:
receiving a captured image of a person who enters/leaves the predetermined area and manages the person recognized from the captured image and the item(s) in an associated manner.

3. The area management apparatus according to claim 1, wherein the processor is configured to execute the instructions to perform:
determining that it is not required to remove the item in a case where the item is necessary in a task or an event that is being carried out in the predetermined area, and
determining that it is required to remove the item in a case where the item is unnecessary in a task or an event that is being carried out in the predetermined area.

4. The area management apparatus according to claim 3, wherein the processor is configured to execute the instructions to perform:
referring to a process table for a task or an event that is being carried out in the predetermined area so as to determine whether it is required or not in the task or event that is being carried out in the predetermined area.

5. The area management apparatus according to claim 3, wherein the processor is configured to execute the instructions to perform:
in a case where the item is positioned in a predetermined unattending-prohibition area,
determining that the item is required to be removed regardless of the necessity/unnecessity of the item in the task or the event.

6. The area management apparatus according to claim 1, wherein the processor is configured to execute the instructions to perform:
holding contact address information of the person(s) who enters/leaves the predetermined area, and
sending a message to the contact address of the person(s) who introduced the item into the predetermined area so as to request removal of the item in the unattended state.

7. The area management apparatus according to claim 1, wherein the processor is configured to execute the instructions to perform:
holding contact address information of member(s) who belongs to the same group as the person(s) who enters/leaves the predetermined area, and
sending a message to a contact address of a member who belongs to the same group as the person who introduced the item into the predetermined area in addition to the person who introduced the item so as to request removal of the item in the unattended state.

8. An area management method, wherein a computer is configured to perform:
managing person(s) who enters/leaves a predetermined area and item(s) that has/have been introduced into the predetermined area by the person(s) in an associated manner,
determining whether it is required or not to remove an item introduced into the predetermined area when the item is brought into an unattended state, and
requesting at least a person associated with the item being in the unattended state to remove the item in a case where it is determined that the item is required to be removed.

9. A non-transient computer-readable storage medium storing a program, wherein the program causes a computer to execute:
a process of managing person(s) who enters/leaves a predetermined area and item(s) that has/have been introduced into the predetermined area by the person(s) in an associated manner:
a process of determining whether it is required or not to remove an item introduced into the predetermined area when the item is brought into an unattended state, and
a process of requesting at least a person associated with the item being in the unattended state to remove the item in a case where it is determined that the item is required to be removed.

10. The area management method according to claim 8, wherein the computer is configured to perform:
receiving a captured image of a person who enters/leaves the predetermined area and manages the person recognized from the captured image and the item(s) in an associated manner.

11. The area management method according to claim 8, wherein the computer is configured to perform:
determining that it is not required to remove the item in a case where the item is necessary in a task or an event that is being carried out in the predetermined area, and
determining that it is required to remove the item in a case where the item is unnecessary in a task or an event that is being carried out in the predetermined area.

12. The area management method according to claim 11, wherein the computer is configured to perform:
referring to a process table for a task or an event that is being carried out in the predetermined area so as to determine whether it is required or not in the task or event that is being carried out in the predetermined area.

13. The area management method according to claim 11, wherein the computer is configured to perform:
in a case where the item is positioned in a predetermined unattending-prohibition area, determining that the item is required to be removed regardless of the necessity/unnecessity of the item in the task or the event.

14. The area management method according to claim 8, wherein the computer is configured to perform:
holding contact address information of the person(s) who enters/leaves the predetermined area, and
sending a message to the contact address of the person(s) who introduced the item into the predetermined area so as to request removal of the item in the unattended state.

15. The area management method according to claim 8, wherein the computer is configured to perform:
holding contact address information of member(s) who belongs to the same group as the person(s) who enters/leaves the predetermined area, and
sending a message to a contact address of a member who belongs to the same group as the person who introduced the item into the predetermined area in addition to the person who introduced the item so as to request removal of the item in the unattended state.

16. The non-transient computer-readable storage medium according to claim 9, wherein the program causes the computer to execute:
a process of receiving a captured image of a person who enters/leaves the predetermined area and manages the person recognized from the captured image and the item(s) in an associated manner.

17. The non-transient computer-readable storage medium according to claim 9, wherein the program causes the computer to execute:
a process of determining that it is not required to remove the item in a case where the item is necessary in a task or an event that is being carried out in the predetermined area, and
a process of determining that it is required to remove the item in a case where the item is unnecessary in a task or an event that is being carried out in the predetermined area.

18. The non-transient computer-readable storage medium according to claim 17, wherein the program causes the computer to execute:
a process of referring to a process table for a task or an event that is being carried out in the predetermined area so as to determine whether it is required or not in the task or event that is being carried out in the predetermined area.

19. The non-transient computer-readable storage medium according to claim 17, wherein the program causes the computer to execute:
in a case where the item is positioned in a predetermined unattending-prohibition area, a process of determining that the item is required to be removed regardless of the necessity/unnecessity of the item in the task or the event.

20. The non-transient computer-readable storage medium according to claim 9, wherein the program causes the computer to execute:
a process of holding contact address information of the person(s) who enters/leaves the predetermined area, and
a process of sending a message to the contact address of the person(s) who introduced the item into the predetermined area so as to request removal of the item in the unattended state.
